(19) United States
(12) Patent Application Publication
(10) Pub. No.: US 2024/0342659 A1
(43) Pub. Date: Oct. 17, 2024

(54) DEVICES AND METHODS FOR ENLARGING VALVE ANNULUS FOR INDUCED VENTRICULAR GROWTH IN SINGLE VENTRICLE PATIENTS

(71) Applicant: The Board of Trustees of the Leland Stanford Junior University, Stanford, CA (US)

(72) Inventors: Kyung Won Han, Stanford, CA (US); Alison Marsden, Palo Alto, CA (US); Mark R. Cutkosky, Palo Alto, CA (US); Michael Ma, Palo Alto, CA (US)

(21) Appl. No.: 18/643,467

(22) Filed: Apr. 23, 2024

Related U.S. Application Data
(63) Continuation-in-part of application No. 18/070,179, filed on Nov. 28, 2022, now abandoned.
Application No. 18/070,179 is a continuation of application No. 14/769,601, filed on Aug. 21, 2015, now abandoned.
(60) Provisional application No. 61/771,041, filed on Feb. 28, 2013.

(51) Int. Cl. B01D 63/10; B01D 65/08; B32B 7/14; B32B 27/12

(52) U.S. Cl. CPC B01D 63/1031; B01D 63/106; B01D 63/107; B01D 65/08; B32B 7/14; B32B 27/12; B01D 2313/14; B01D 2313/143; B01D 2321/2016; B32B 2255/02; B32B 2255/26; B32B 2262/0276; B32B 2307/726

(57) ABSTRACT

Devices and methods are provided for inducing ventricular growth in a single ventricle patient that include a plurality of anchors spaced apart from one another in an annular configuration; a plurality of springs with respective springs coupled to adjacent anchors around a perimeter of the annular configuration to bias the anchors to expand radially outwardly; and one or more elongate elements extending around the perimeter between the anchors to limit radial expansion of the anchors.

### RELATED APPLICATION DATA

The present application is a continuation of co-pending International Application No. PCT/US2022/048089, filed Oct. 27, 2022, which claims priority to U.S. provisional application Ser. No. 63/272,510, filed Oct. 27, 2021, the entire disclosures of which are expressly incorporated by reference herein.

### TECHNICAL FIELD

The present application related to medical devices and, more particularly to devices for inducing ventricular growth in single ventricle patients and to methods for implanting and using such devices.

### BACKGROUND

Existing treatments for single-ventricle patients are palliative in nature. Avenues for biventricular restoration have largely been limited to mechanical circulatory support (MCS) devices and cardiac transplantation. MCS devices pose a high risk for thrombolytic events, and cardiac transplantation is limited by the amount of donor hearts.

Current surgical palliation for single ventricle physiology involves bypassing the hypoplastic ventricle to convert the circulation into a one-pump system. Within this paradigm, most current research in myocardial biology and surgical methods is directed towards maintaining the health and function of the systemic single ventricle for as long as possible. Thus, the current treatment of complex single ventricle patients is primarily palliative in nature, and less attention has been paid to strategies for restoring biventricular or one—and-a-half ventricle circulation towards a true functional cure. Avenues for biventricular restoration have largely been limited to mechanical circulatory support devices and cardiac transplantation, with less attention paid to technologies aimed at regrowing or salvaging the existing ventricle. Therefore, devices and methods for treating patients with hypoplastic ventricle would be useful.

### SUMMARY

The present application is directed to medical devices and, more particularly to devices for inducing ventricular growth in single ventricle patients and to methods for implanting and using such devices. The devices and methods herein may induce favorable growth, e.g., by exerting stimuli on the myocardial tissue of the hypoplastic ventricle to partially or fully restore size and function of the patient's heart.

For example, the devices disclosed herein may induce favorable ventricular growth to restore a healthy bi-ventricular cardiac system for single ventricle patients with a hypoplastic mitral valve. Studies have shown that increasing blood flow through a hypoplastic ventricle can stimulate load—and flow-mediated growth. Therefore, a compliant expander is disclosed herein that enlarges the annulus of a hypoplastic mitral valve (MV) to facilitate increased blood flow and thereby induce ventricular chamber growth. The compliant MV expander includes a simple, circular connection of springs and anchors. The anchors may be sutured along the MV annulus, similar to annuloplasty ring implantation. This device also features bio-absorbable material that will allow for the incremental expansion of the device every few weeks over several months. The attachment and mechanism of expansion were tested on an explanted fetal bovine heart and demonstrated 25% annular expansion.

In one example, the device may be designed to be implanted on a neonate's heart for several months to induce tissue growth of the hypoplastic ventricle to treat single ventricle patients.

In accordance with one example, a device is provided for inducing ventricular growth in a single ventricle patient that includes a plurality of anchors spaced apart from one another in an annular configuration; a plurality of springs with respective springs coupled to adjacent anchors around a perimeter of the annular configuration to bias the anchors to expand radially outwardly; and one or more elongate elements extending around the perimeter between the anchors to limit radial expansion of the anchors.

In accordance with another example, a method is provided for inducing ventricular growth in a single ventricle patient that includes providing an annular valve expander defining an annular shape and including a plurality of anchors spaced apart from another around a perimeter of the valve expander and springs coupled to adjacent anchors around the perimeter to bias the anchors to expand radially outwardly; implanting the valve expander to a native valve annulus of the patient's heart, e.g., of the mitral valve; and allowing the bias of the springs to enlarge the valve annulus to induce ventricular chamber growth. For example, the valve expander may be constrained to an initial size by one or more sutures extending between adjacent anchors around the perimeter, and the method may include cutting one or more sutures between one or more of the adjacent anchors to allow the valve expander to expand radially outwardly to dilate the valve annulus.

Other aspects and features of the present invention will become apparent from consideration of the following description taken in conjunction with the accompanying drawings.

### BRIEF DESCRIPTION OF THE DRAWINGS

It is believed the present invention will be better understood from the following description of certain examples taken in conjunction with the accompanying drawings, in which like reference numerals identify the same elements and in which:

FIGS. 1A-1C show cross-sections of examples of a normal heart (FIG. 1A), a heart with hypoplastic left heart syndrome (FIG. 1B), and a heart with HLHS post-surgery (FIG. 1C).

FIG. 2 shows an example of a valve expander device for inducing ventricular growth in a single ventricle patient.

FIG. 2A is a detail of an anchor for the expander device of FIG. 2.

FIGS. 3A and 3B show additional examples of valve expander devices.

FIG. 4 shows the valve expander device of FIG. 2 implanted within a native valve annulus.

FIGS. 5A and 5B show the expander device of FIG. 2 showing the flexibility of the device to change in shape as a valve annulus moves during the heart cycle.

The drawings are not intended to be limiting in any way, and it is contemplated that various examples of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

Before the examples are described, it is to be understood that the invention is not limited to particular examples described, as such may, of course, vary. It is also to be understood that the terminology used herein is for the purpose of describing particular examples only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials are now described.

It must be noted that as used herein and in the appended claims, the singular forms “a,” “an,” and “the” include plural referents unless the context clearly dictates otherwise. Thus, for example, reference to “a compound” includes a plurality of such compounds and reference to “the polymer” includes reference to one or more polymers and equivalents thereof known to those skilled in the art, and so forth.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

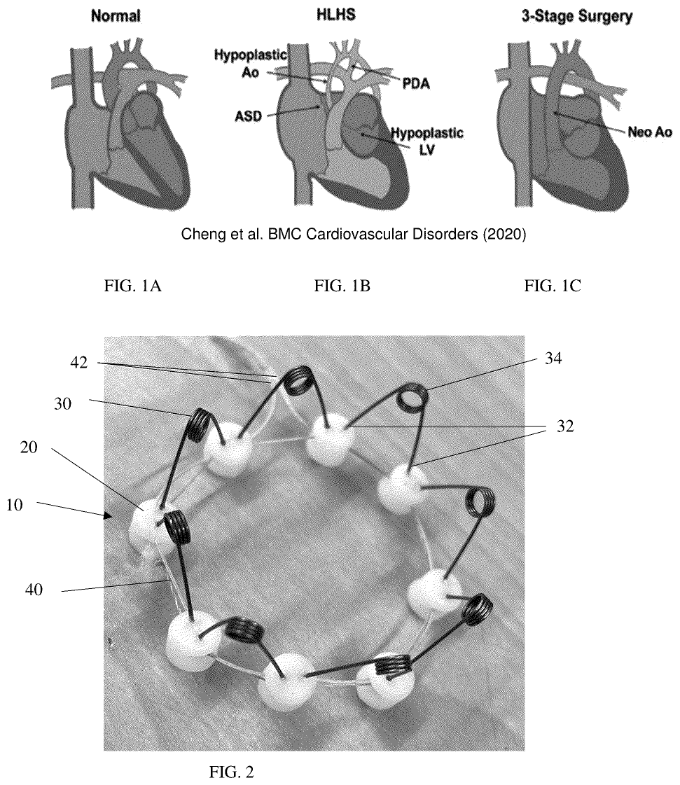

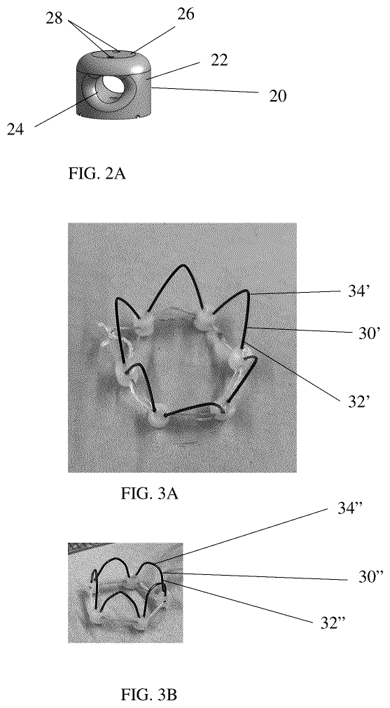

Turning to the drawings, FIG. 2 shows an example of a valve expander device 10 for inducing ventricular growth in a single ventricle patient. As described further herein, such devices may induce favorable growth, e.g., by exerting stimuli on the myocardial tissue of the hypoplastic ventricle to partially or fully restore size and function of the patient's heart. For example, the device 10 may be implanted within a heart of a neonate with hypoplastic left heart syndrome (HLHS), such as that shown in FIG. 1B, e.g., to facilitate increased blood flow and/or induce ventricular chamber growth. Although the expander devices herein are described for particular implantation within or around a mitral valve, the devices may be implanted within or around the annulus of other valves of a subject's heart.

As shown in FIG. 2, the device 10 includes a plurality of anchors 20 connected by a plurality of springs 30 to define an annular shape, i.e., with each spring 30 coupled to adjacent anchors 20 around a perimeter of the device 10 to bias the anchors 20 to expand radially outwardly. One or more elongate elements, e.g., one or more bioabsorbable sutures 40, extend around the perimeter between the anchors 20 to limit radial expansion of the anchors 20.

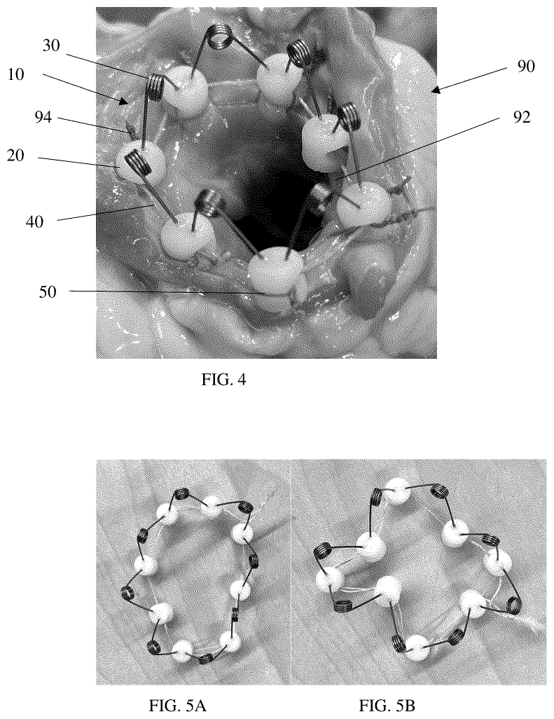

The anchors 20 may be configured to be secured individually to tissue, e.g., spaced apart around or adjacent a native valve annulus, such as the mitral valve 92 of heart 90, e.g., as shown in FIG. 4. For example, as shown in FIG. 2A, each anchor 20 may include a body defining a sidewall 22, e.g., having a cylindrical shape, a lateral passage 24 extending the body between opposite sides of the sidewall 22, and an upper surface 26 including holes, recesses, or other features 28 for coupling springs 30 to the anchor 20, and a lower surface (not shown) that may be placed against tissue adjacent a valve annulus. Optionally, the sidewall 22 may include an annular recess and/or other feature (not shown), e.g., extending at least partially around the circumference of the sidewall 22, configured to receive a suture such that the suture may be directed through tissue to secure the anchor 20 to the tissue, as described elsewhere herein. In addition or alternatively, the anchors 20 may include other features for securing the individual anchors to tissue, e.g., screws, clips, and the like (not shown). The anchors 20 may be manufactured separately, e.g., by one or more of 3D-printing, molding, casting, machining and the like, from biocompatible material, e.g., plastic, metal, or composite material.

Also as shown in FIG. 2, each spring 30 may be an individual elongate wire element defining an arcuate or “V” shape between opposite or lower ends 32 that is bent or curved and then attached to adjacent anchors 20, e.g., with an intermediate region 34 of the spring 30 extending out of a plane defined by the perimeter of the device 10. The springs 30 may be formed from biocompatible elastic or superelastic material, e.g., metal, such as stainless steel or Nitinol, plastic, and the like, that is biased to separate the opposite ends 32, e.g., at least partially straighten the wire elements. With the springs 30 arranged in series around the perimeter of the device, 10, the springs 30 bias the anchors 20 to expand radially outwardly but for the constraint provided by the suture(s) 40.

In the example shown in FIG. 2, the intermediate region 34 includes a plurality of coils formed in the wire to provide a torsion spring that generates the potential spring force separating the ends 32, although, alternatively, other spring features may be provided at the intermediate region 34. For example, as shown in FIGS. 3A and 3B, each spring 30′, 30″ may be formed from a single length of wire that is bent or otherwise deformed at the intermediate region 34′, 34″ to provide a desired shape, e.g., a generally “V” or “U” shape, with the material biased to at least partially straighten the wire to provide a desired potential spring force separating the ends 32′, 32″.

With continued reference to FIG. 2, the ends 32 of the springs 30 may be attached to respective anchors 20 to maintain the device 10 in an enclosed shape, although accommodating changes in shape, e.g., as the valve annulus changes shape during the cardiac cycle, as shown in FIGS. 5A and 5B, and described further elsewhere herein. For example, the end 32 of each spring 30 may be inserted into a respective hole 28 in the upper surface 26 of an anchor 20 and permanently attached, e.g., using one or more of force fit, bonding with adhesive, fusing, welding, and the like.

The passages 24 through the sidewall 22 of each anchor 20 may be generally aligned around the perimeter of the device 10 and one or more sutures 40 may be received through the passages 24 around the perimeter to limit expansion of the device 10. For example, as shown in FIG. 2, a pair of sutures 40, 42 may be directed around the perimeter through the passages 24 and then, after tightening the sutures 40, 42 to constrain the device 10 at a desired diameter, ends of the sutures 40, 42 may be attached together, e.g., by one or more of knotting, bonding with adhesive, sonic welding, fusing, and the like, to limit subsequent expansion. Alternatively, a connector, e.g., a crimped tab, button, and the like (not shown) may be attached to the ends to secure the ends together, yet may be adjustable, e.g., to loosen the suture 40 if desired, e.g., to increase the maximum diameter of the device 10 after implantation.

Optionally, the suture(s) 40, 42 may be secured between adjacent anchors 20, e.g., by introducing the sutures 40, 42 through the passage 24 one or more times, e.g., wrapping the suture around the sidewall 22 and/or by knotting one or more knots between adjacent anchors 20, to further constrain the device 10. Thus, if a length of suture between two adjacent anchors is severed or otherwise separated, the spring 30 between those anchors 20 may be released to provide additional bias while the other anchors 20 remain constrained.

The suture(s) 40, 42 may be formed from biocompatible material that remains indefinitely along with the anchors 20 and springs 30. Alternatively, the suture(s) 40, 42 may be bioabsorbable such that they dissolve over a predetermined time, e.g., to release the springs 30 without requiring further intervention. For example, as shown in FIG. 2, one suture 40 may be formed from bioabsorbable material such that the suture 40 may dissolve and/or break after a desired period of time, while the other suture 42 remains intact. In this example, the second suture 42 may have a longer circumferential length than the first suture 40, e.g., such that when the bioabsorbable suture 40 dissolves or breaks, the device 10 may be free to expand further, yet be constrained by the circumferential length of the other suture 42.

Optionally, a plurality of bioabsorbable sutures may be provided for constraining the device 10 with each suture having a different circumferential length and dissolving time. For example, a plurality of sutures may be provided that have incrementally longer lengths, with the longer sutures having slower dissolving times. Thus, the shortest suture may initially constrain the device and, once the shortest suture dissolves or breaks, the next suture may constrain the device until it dissolves or breaks, etc., thereby allowing the device 10 to slow expand over time.

Optionally, the device 10 may include Dacron, fabric, mesh and/or covering one or more components of the device 10, e.g., to reduce the risk of thrombosis and/or prevent components of the device 10 from being released into the patient's heart. For example, an annular fabric or mesh covering may be provided around the anchors 20 and sutures 40, 42, e.g., to prevent pieces of bioabsorbable sutures from escaping as they dissolve.

During use, the device 10 may be implanted within a patient's heart 90, e.g., within or adjacent a mitral valve annulus 92, e.g., as shown in FIG. 4. The device 10 may be provided with the springs 30 applying a desired bias to the anchors 20 but for the constraint of the suture(s) 40. In one example, the device 10 may be introduced into the patient's heart 90 using conventional methods, e.g., during an open-heart or minimally invasive procedure, and positioned adjacent the target annulus 92, e.g., with the lower surfaces of the anchors 20 placed against tissue adjacent the annulus 92.

Individual sutures 94 and/or other fasteners may then be used to secure each anchor 20 to the tissue of the annulus 92. For example, as shown in FIG. 4, a suture 50 may be directed through each of the passages 24 and through tissue adjacent the annulus 92, e.g., using a needle or other instrument (not shown), and then ends of the suture 50 may be secured together, e.g., by one or more of knotting, bonding with adhesive, sonic welding, fusing, and the like. The implanted 10 device may apply a radially outward bias to the tissue and,

consequently, to the annulus 92, which may induce favorable growth and/or otherwise treat the annulus 92 and/or surrounding myocardial tissue. The implanted device 10 may then remain within the heart 90 for a desired time period allowing the bias of the springs 30 to enlarge the valve annulus 92 to induce ventricular chamber growth. For example, as shown in FIGS. 5A and 5B, although the springs 30 may bias the device 10 to a desired diameter and/or other enclosed shape and/or size, the springs 30 may accommodate dynamic changes, e.g., as the valve annulus 92 moves during the cardiac cycle. The properties of the springs 30 may be selected to accommodate movement of the valve annulus 92, e.g., during normal beating of the heart 90.

After a desired time period, one or more lengths of the sutures 40, e.g., between one or more of the adjacent anchors 20 may be cut to allow the device 10 to expand radially outwardly due to the forces of the now-released spring(s) 30 to dilate the valve annulus 92. For example, a cutting instrument (not shown) may be introduced into the patient's heart, e.g., endovascularly from a percutaneous access location or directly through the wall of the heart. Alternatively, if an adjustable connector is used to secure the ends of the suture 40, the connector may be manipulated to loosen the suture 40. If desired, this procedure may be repeated one or more times. In another alternative, if the suture 40 is bioabsorbable, the suture may dissolve over time to release the springs over a desired time period.

Alternatively, if the device 10 includes one or more bioabsorbable sutures, the sutures may dissolve or break after a desired period time, with one or more additional bioabsorbable or permanent sutures continuing to limit expansion, e.g., such that the device may expand over time without requiring further intervention to cut the suture(s).

The resulting bias from the device 10 may apply controlled mechanical stimuli to the myocardial tissue of the left ventricle to partially or fully restore size and function to the left ventricle of the patient. After a desired period of time, the device 10 may be removed from the patient's heart using conventional methods.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A device for inducing ventricular growth in a single ventricle patient, comprising:
a plurality of anchors spaced apart from one another in an annular configuration;
a plurality of springs with respective springs coupled to adjacent anchors around a perimeter of the annular configuration to bias the anchors to expand radially outwardly; and
one or more elongate elements extending around the perimeter between the anchors to limit radial expansion of the anchors.

2. The device of claim 1, wherein the springs are arranged in series around the perimeter.

3. The device of claim 1, wherein the anchors lie within a plane and wherein each spring comprises an elongate element defining an arcuate or “V” shape between opposite ends that are attached to adjacent anchors.

4. The device of claim 3, wherein each elongate element extends out of the plane between the adjacent anchors.

5. The device of claim 1, wherein the springs comprise torsion springs.

6. The device of claim 1, wherein the springs comprise Nitinol wire.

7. The device of claim 1, wherein the anchors are configured to be secured to a valve annulus within the patient's heart.

8. The device of claim 1, wherein the elongate elements are severable between adjacent anchors to increase a size of the perimeter.

9. The device of claim 1, wherein the elongate elements comprise one or more sutures.

10. The device of claim 9, wherein the one or more sutures are bioabsorbable.

11. The device of claim 1, wherein each anchor comprises a passage therethrough that receives the one or more elongate elements therethrough.

12. The device of claim 11, wherein each anchor comprises a circular sidewall and wherein the passage extends between opposite sides of the sidewall.

13. The device of claim 11, wherein each anchor comprises an upper surface including one or more features for receiving ends of adjacent springs therein.

14. A device for inducing ventricular growth in a single ventricle patient, comprising:
a plurality of anchors spaced apart from one another in an annular configuration, each anchor comprising a passage therethrough;
a plurality of springs with respective springs coupled to adjacent anchors around a perimeter of the annular configuration to bias the anchors to expand radially outwardly; and
one or more sutures extending through the passages around the perimeter between the anchors to limit radial expansion of the anchors.

15. The device of claim 14, wherein the anchors lie within a plane and wherein each spring comprises first and second ends and an intermediate region between the first and second ends defining an arcuate or “V” shape, the first and second ends attached to adjacent anchors.

16. The device of claim 15, wherein the first and second ends are inserted into respective holes in the adjacent anchors.

17. The device of claim 14, wherein the one or more sutures comprises at least one bioabsorbable suture and at least one permanent suture to limit expansion of the device.

18. The device of claim 17, wherein the at least one bioabsorbable suture comprises a first suture having a first circumferential length and the at least one permanent suture comprises a second suture having a second circumferential length that is longer than the first circumferential length such that the first suture constrains the device until the first suture dissolves or breaks, whereupon the second suture allows the device to expand yet constrain the device.

19. (canceled)

20. A system for inducing ventricular growth in a single ventricle patient, comprising:
i) an implantable device comprising:
a plurality of anchors spaced apart from one another in an annular configuration, each anchor comprising a passage therethrough;
a plurality of springs with respective springs coupled to adjacent anchors around a perimeter of the annular configuration to bias the anchors to expand radially outwardly; and
one or more sutures extending through the passages around the perimeter between the anchors to limit radial expansion of the anchors; and
ii) a cutting instrument comprising a distal end sized for introduction into the patient's heart to cur the one or more sutures to release one or more of the springs.

21. The system of claim 20, further comprising an instrument for delivering fasteners through the anchors to secure the anchors to tissue.

22-27. (canceled)
